(19) United States
(12) Patent Application Publication
(10) Pub. No.: US 2025/0380098 A1
(43) Pub. Date: Dec. 11, 2025

(54) ACOUSTIC CAMERA SYSTEM

(71) Applicant: CAE Software und Systems GmbH, Gütersloh (DE)

(72) Inventors: Kai-Uwe Kohn, Rheda-Wiedenbrück (DE); Nico Zurmühlen, Gütersloh (DE)

(73) Assignee: CAE Software und Systems GmbH, Gütersloh (DE)

(21) Appl. No.: 19/208,966

(22) Filed: May 15, 2025

(30) Foreign Application Priority Data
Jun. 7, 2024 (EP) 24180866.6

(51) Int. Cl. H04R 29/00; H04R 1/02

(52) U.S. Cl. CPC H04R 29/005; H04R 1/028; H04R 2499/11

(57) ABSTRACT

An acoustic camera system has a microphone unit and a mobile device, in particular a tablet or smartphone, wherein the mobile device has a camera, a data interface and a display. The microphone unit has a data interface which is or can be coupled to the data interface of the mobile device via a connection. The microphone unit has a microphone array with a plurality of microphones and an evaluation unit which receives data from the microphones.

### CROSS REFERENCE TO RELATED APPLICATIONS

This application claims priority on and the benefit of European Patent Application No. 24 180 866.6 having a filing date of 7 Jun. 2025.

### BACKGROUND OF THE INVENTION

### Technical Field

The invention relates to an acoustic camera system.

### Prior Art

Appropriate camera systems are used to locate sound sources and visualize them on a display. A sound source is recorded via a microphone array so that spatial acoustic data about the sound source is available. At the same time, the area of the sound source is recorded using a camera. By combining the spatial signal data captured from the microphone array with the recorded video image, the sound source can be identified in the video image.

Due to the wealth of data generated by recording the acoustic signals captured by the microphone array, a relatively high level of computing power is required to process the corresponding data in real time.

Due to the required computing power, the application is limited, especially when using an acoustic camera on a mobile basis. This is because conventional portable mobile devices are generally not equipped with the capabilities to process complex signals in real time.

It is therefore the object of the invention to further develop an acoustic camera system of the type mentioned at the outset in such a way that it is particularly suitable for mobile use.

### BRIEF SUMMARY OF THE INVENTION

This object is achieved by an acoustic camera system having a microphone unit and a mobile device, in particular a tablet or smartphone, wherein the mobile device comprises a camera, a data interface and a display, wherein the microphone unit comprises a data interface which is coupled or can be coupled to the data interface of the mobile device via a connection, wherein the microphone unit comprises a microphone array with a plurality of microphones and an evaluation unit which receives data from the microphones. Advantageous embodiments can be found in the dependent claims.

An acoustic camera system according to the invention has a microphone unit and a mobile device, in particular a tablet or smartphone, wherein the mobile device comprises a camera, a data interface and a display. Here, mobile devices are deliberately used as the basic device, as they are common and therefore widely available on the market. The microphone unit of the acoustic camera system according to the invention comprises a data interface which is or can be coupled to the data interface of the mobile device via a connection. The microphone unit is therefore a supplement to the mobile device and is connected to it via a corresponding interface. Furthermore, the microphone unit of the acoustic camera system according to the invention comprises a microphone array with a plurality of microphones and an evaluation unit that receives data from the microphones. The microphone array allows the sound sources to be resolved directionally and spatially. Since the evaluation of the data collected by the microphone array can place a heavy or even excessive strain on a mobile device, a separate evaluation unit is housed in the microphone unit, which evaluates the data or at least pre-evaluates it.

The evaluation unit preferably comprises an FPGA or ASIC. This allows the use of an evaluation unit specific to the microphone unit, which can be pre-programmed or programmed on site. Costs can be reduced by using application-specific standard products.

It has proven advantageous that the microphone unit is supplied with power via the connection via the power supply, in particular in the form of a battery, of the mobile device. This allows the microphone unit to be built compactly and lightweight, making the entire acoustic camera system easy to handle as a mobile device.

It is also advantageous if the microphone unit is connected or can be connected to the mobile device via a mechanical coupling. This reinforces the unity of the mobile device and the microphone unit, which underlines the character of a mobile acoustic camera.

It has proven particularly advantageous if software is installed on the mobile device which is configured to receive data from the evaluation unit or to transmit it to the evaluation unit, and/or to display information concerning the data generated by the evaluation unit and/or an image or video generated by the camera on the display. The software installed on the mobile device is configured to communicate with the evaluation unit of the microphone unit. For example, it can transmit images from the optical camera and save the evaluated data from the microphone unit and/or make them available via the output units available in the mobile device, such as the screen and/or loudspeaker/headphones. For example, if the image from the acoustic camera is combined with that from the optical one, a noise source can be easily located, and an acoustic output of the noise via the loudspeaker/headphone can then provide the user with further information.

When it comes to optical output, it has proven particularly advantageous if the display unit is designed as a touchscreen. By selecting specific areas, the microphone array can be focused on specific selected points to examine specific sound sources more closely.

### BRIEF DESCRIPTION OF THE DRAWINGS

The invention will be explained in more detail with reference to an exemplary embodiment and the following figures.

FIG. 1 shows a perspective view of an acoustic camera system based on a smartphone.

FIG. 2 also shows in perspective view the acoustic camera system in which the microphone unit has been separated from the mobile device.

FIG. 3 shows a block diagram of an acoustic camera system.

### DETAILED DESCRIPTION OF PREFERRED EMBODIMENTS

FIG. 2 shows a perspective view of the two main elements 2, 3 of an acoustic camera system 1. In this exemplary embodiment, the mobile device 2 is a smartphone, which is shown from the rear side 26 because it would not make sense to arrange the microphone unit 3 at the front of the display 25, the screen. The optical camera 22 is located at the top left of the rear side 26. Also important for the acoustic camera system 1 is the data interface 41 of the mobile device 2.

The microphone unit 3 is shown above the mobile device 2. On the side facing away from the mobile device 2, a microphone array 32 consisting of a plurality of microphones 32a is arranged. The microphone array 32 is coupled to the evaluation unit 31, which is provided with a connection to a data interface 42 adapted to the mobile device.

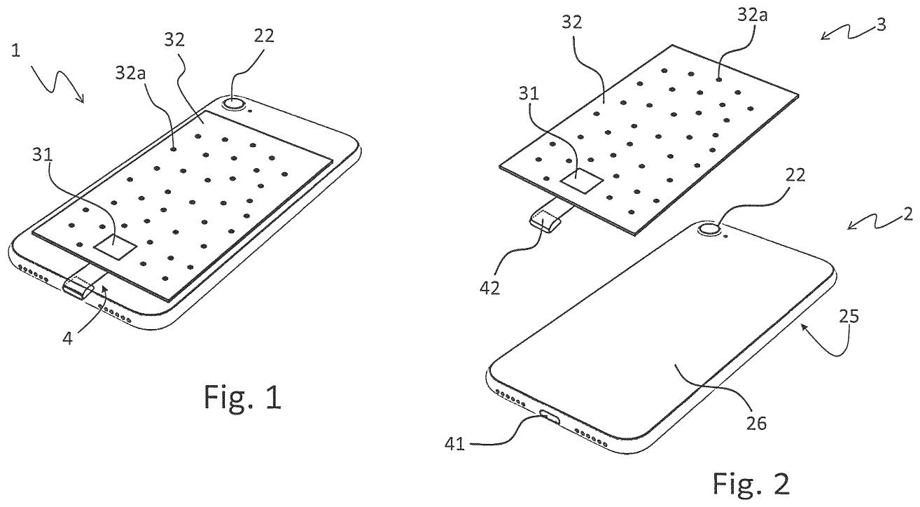

In FIG. 1, the two parts 2, 3 of the acoustic camera system 1, the mobile device 2 and the microphone unit 3 are joined together. The data interface of the microphone unit 42 is connected to the data interface 41 of the mobile device 2, whereby the acoustic camera system is/can be put into operation. The microphone unit 3 is detachably arranged on the rear side 26 of the mobile device 2. In this embodiment, the dimensions of the microphone unit 3 are smaller than those of the mobile device 2. This has the advantage that the forces that hold the microphone unit 2 on the mobile device 2 can be small, since the forces that could lift the microphone unit 3 from the mobile device 2 have little surface area to act on. Thus, the microphone unit 3 can be designed to be held by van der Waals forces, slight adhesive forces or other adhesion forces. In this case, the microphone unit 3 can also be kept quite flexible, since dimensional stability is provided by nestling against the mobile device 2. Of course, other fastening options are also conceivable, for example, magnetic connections or form and/or force connections such as clip connections. A larger surface area of the microphone unit 3 increases the resolution of the measurements, but requires greater internal stability, which would make the acoustic camera system 1 more difficult to handle.

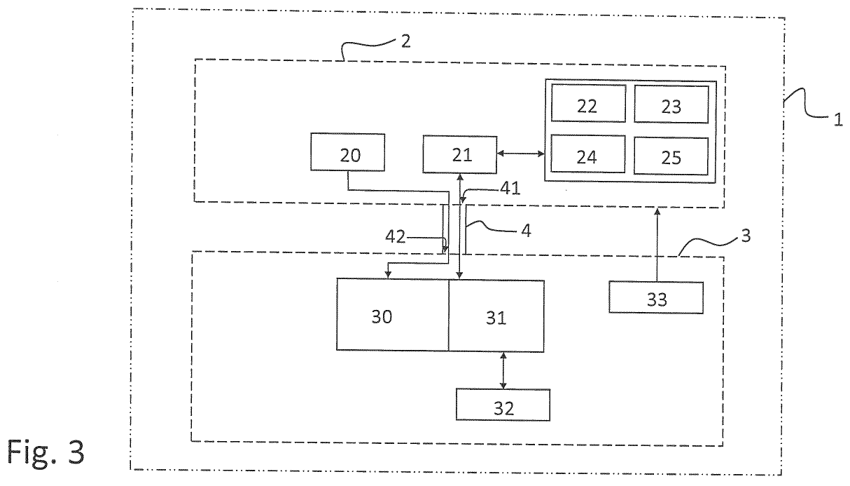

FIG. 3 shows the block diagram of an acoustic camera system 1 according to the invention. The mobile device 2 has a power supply 20 for operating the device. Software 21 is installed on the mobile device 2, which communicates with the camera 22 and possibly other sensors 23 via an interface 24 and can control the output 25, a screen and/or a loudspeaker.

If the microphone unit 3 is connected to the mobile device 2 via the connection 4 with the interfaces 41, 42, the microphone unit is also supplied with voltage 30 through the connection if the microphone unit 3 does not have its own voltage supply 30. The microphone unit is arranged on the mobile device 2 by means of a fastening system 33, which is preferably done on the rear side 26 of the mobile device 2.

The evaluation unit 31 analyzes the data from the microphone array 32 and forwards the evaluation data to the software 21 via the connection 4. Depending on the setting, the software 21 can combine the data from the microphone array 32 with the images from an internal optical camera 22 and display them on the display 25. This allows for an acoustic analysis to be carried out in real time and acoustic disturbances to be detected and possibly eliminated. For this purpose, the software 21 can control the evaluation unit 31 in such a way that it focuses on certain spatial directions and distances, thus enabling a more detailed picture of the surroundings.

It is also possible for the software 21 to store the evaluation data of the evaluation unit 31 together with data from sensors and/or the optical camera 22 and thus to supply them for later comprehensive evaluation.

An acoustic camera system 1 according to the invention provides a lightweight and cost-effective device that allows quick and easy use in the field. Cost-effective, especially because a common mobile device 2 is used, and “only” the appropriate software needs to be installed and a microphone unit needs to be connected to it.

It is also possible to change the number of microphones 32a in the microphone array 32. If fewer microphones 32a are used, the energy consumption and the evaluation time are reduced, although the spatial resolution decreases. If the selection of the microphones 32a is done electronically, an acoustic overview can be created with just a few microphones 32a in an energy-saving manner. At interesting points, a detailed analysis can be carried out by connecting additional microphones 32a in order to increase the spatial and acoustic resolution.

### LIST OF REFERENCE SIGNS

1 Acoustic camera system
2 Mobile devices
3 Microphone unit
4 Connection
Power supply
21 Software
22 Camera
23 Sensor (other)
24 Interface
Display
26 Rear side
Power supply
31 Evaluation unit
32 Microphone array
32a Microphone
33 Fastening system
41 Data interface
42 Data interface

What is claimed is:

1. An acoustic camera system (1), having a microphone unit (3) and a mobile device (2), in particular a tablet or smartphone, wherein the mobile device comprises a camera (22), a data interface (41) and a display (25), wherein the microphone unit (3) comprises a data interface (42) which is coupled or can be coupled to the data interface (41) of the mobile device (2) via a connection (4), wherein the microphone unit (3) comprises a microphone array (32) with a plurality of microphones (32a) and an evaluation unit (31) which receives data from the microphones (32a).

2. The acoustic camera system (1) according to claim 1, wherein the evaluation unit (31) comprises an FPGA orASIC.

3. The acoustic camera system (1) according to claim 1, wherein the microphone unit (3) is supplied with voltage via the voltage supply (20), in particular in the form of a battery of the mobile device (2) via the connection (4).

4. The acoustic camera system (1) according to claim 1, wherein the microphone unit (3) is connected or connectable to the mobile device (2) via a mechanical coupling.

5. The acoustic camera system (1) according to claim 1, wherein software (21) is installed on the mobile device, which software is configured to receive data from the evaluation unit (31) or to transmit it to the evaluation unit (31), and/or to display information concerning the data generated by the evaluation unit (31) and/or an image or video generated by the camera (22) on the display (25).

6. The acoustic camera system (1) according to claim 1, wherein the display unit is designed as a touchscreen.
